(19) United States
(12) Patent Application Publication
(10) Pub. No.: US 2018/0257318 A1
(43) Pub. Date: Sep. 13, 2018

(54) METHOD FOR THE CONTINUOUS PRODUCTION OF A COMPOSITE MATERIAL PROFILE SECTION FROM THERMOPLASTIC POLYMER HAVING HIGH FLUIDITY

(71) Applicants: RHODIA OPERATIONS, Paris (FR); CENTRE TECHNIQUE DES INDUSTRIES MECANIQUES (CETIM), Senlis (FR)

(72) Inventors: Gilles ORANGE, Vourles (FR); Didier TUPINIER, Assieu (FR); Philippe PAPIN, Bievres (FR); Mickaeel AUBRY, Belligné (FR); Jean-Michel LEBRUN, Nantes (FR); Sébastien COMAS-CARDONA, Nantes (FR)

(21) Appl. No.: 15/536,953

(22) PCT Filed: Dec. 21, 2015
(86) PCT No.: PCT/EP2015/080785

§ 371 Date: Jun. 16, 2017

(30) Foreign Application Priority Data
Dec. 22, 2014 (FR) 1463113

(51) Int. Cl. B29C 70/52; B29C 70/06

(52) U.S. Cl. CPC B29C 70/523; B29C 70/527; B29K 2077/00; B29C 70/06; B29C 70/528

(57) ABSTRACT

The invention relates to a method for continuous production of a composite material profile by injection-pultrusion from at least one reinforcing fabric and at least one thermoplastic polymer having high fluidity, said method being characterized in that:
i) said fabric is continuously pulled with a pulling speed of at least 0.4 m·min⁻¹ in the course of said process;
ii) the impregnation stage is performed by injection of a polymeric composition having high fluidity through the fabric;
iii) the profile is then shaped with a specific thermal profile.

The invention also relates to a profile obtained according to the method of the invention and a composite article comprising such a profile the curvature whereof may be modified in its curvature by bending and/or its profile by rotational molding.

The present invention relates to the field of composite materials, and more particularly that of composite profiles, manufactured via the impregnation of a fabric (reinforcing material) with at least one thermoplastic polymer having high fluidity in the molten state, and method for production thereof in particular by a pultrusion technique.

Composite profiles are now high performance materials for mass market industries such as ground transport (automobiles . . . ), energy, sport and leisure, agricultural machinery or civil engineering, or more limited, but developing markets such as aerospace. In fact they have good intrinsic mechanical performance, in particular ductility and impact resistance, good chemical stability, particularly towards solvents and total recyclability for high performance injection molded parts.

Pultrusion technology, used in particular for producing such composite profiles, is a production method according to which a reinforcement, for example fibers packed in coils, is impregnated with a polymeric matrix by passing into a bath of liquid monomer or molten polymer and pulled through a channel which progressively ensures the shaping of the composite material to the profile to be produced.

It should be noted that thermoplastic resins are nowadays preferred for forming the matrix of these profiles in comparison to the widely utilized thermosetting resins which require the use of solvents and of monomers and resulting in non-recyclable products.

However, the continuous development of reinforced thermoplastic profiles by pultrusion is currently limited particularly with regard to problems of implementation and associated cost.

Thus, the thermoplastic polymers available on the market have a high viscosity in the molten state, typically greater than 200 Pa·s, which renders the impregnation of the reinforcing fabrics difficult and above all when the proportion of fibers becomes large, in particular when it is greater than 50% by volume. The utilization of this type of polymer requires prolonged impregnation times, that is to say a slow or very slow reinforcing material pulling speed, and substantial operating pressures which requires the presence of baffles (bar feed) or wire guides within the device. In the majority of cases, the profiles obtained from these matrices may have microcavities and poorly impregnated zones prejudicial to their mechanical properties. This phenomenon of loss of mechanical properties is moreover accentuated when the reinforcing fabric pulling speed increases.

Further, the high viscosity level of these polymers imposes limits. Only the production of bands of low thickness (tapes), i.e. less than 1 mm, on the basis of a unidirectional reinforcement is found to be possible under acceptable speed conditions. Finally, it is not compatible with an injection-pultrusion technique which consists in injecting into a channel, so-called hot channel, the molten polymer for the purposes of impregnating the reinforcement, alone or in combination with a unidirectional reinforcement, generally a continuous fabric or a tape, likewise introduced into this hot channel.

Now this injection technique is found to be particularly advantageous in the industrial context, as it is compatible with a continuous mode of production and with a high production rate. In fact, the reinforcing material impregnated by injection is continuously pulled via a pulling system, in order to be introduced into a shaping device.

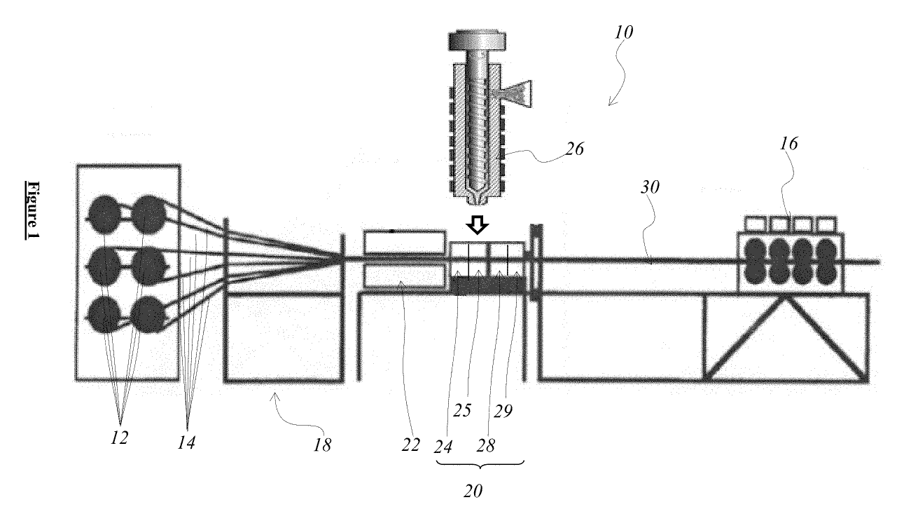

FIG. 1 precisely displays a channel assembly suitable for the implementation of this technology. It should be noted that the space devoted to the shaping of the impregnated fabric may correspond to a zone which is colder than the channel devoted to the impregnation as illustrated in this FIG. 1, but may equally be constituted of a second so-called cold channel, located in continuation, immediate or otherwise, of the hot channel.

Unfortunately, this injection technology may also exhibit malfunctions such as for example an undesirable phenomenon of outflow of the polymer at the entrance to the hot channel or an effect of swelling of the profile, or again a problem of blockage in the shaping zone due to excessive friction between the profile and the channel.

There thus remains a need for a technique for producing composite profiles based on a thermoplastic material, compatible with a production mode which is continuous and free from the aforesaid problems.

Contrary to all expectation, the inventors have now found that it is possible to produce thermoplastic composite profiles continuously and with high throughput by means of an injection-pultrusion technique, provided that a specific type of polymer is concerned and the profile is formed while controlling its thermal profile during its shaping.

Thus, according to one of its aspects, the present invention relates to a method for the continuous production by injection-pultrusion of a composite material profile from at least one reinforcing fabric and at least one thermoplastic polymer, said method comprising at least the stages consisting of:
a) having available a thermoplastic polymeric composition of viscosity less than or equal to 50 Pa·s and based on one or more thermoplastic polymers in the molten state and,
b) having available a reinforcing fabric at a temperature less than 400° C., preferably 350° C., and greater than or equal to the temperature of said polymeric composition in the molten state,
c) impregnating said fabric from stage b) with said polymeric composition from stage a);
d) shaping said fabric impregnated with said polymeric composition to form said profile,
   characterized in that:
i) said fabric is continuously pulled with a pulling speed of at least 0.4 m·min⁻¹ in the course of said process;
ii) the impregnation stage c) is performed by injection of said polymeric composition in the molten state through the fabric;
iii) the profile is shaped in stage d) with a thermal profile such that:
   its surface temperature is less than the crystallization temperature of said polymeric composition if semi-crystalline and less than 125° C. above the glass transition temperature (Tg) of said polymeric composition if amorphous, and
   its core temperature is greater than the crystallization temperature of said polymeric composition if semi-crystalline and higher than 50° C. above the glass transition temperature (Tg) of said polymeric composition if amorphous.

In the present text, the term “thermoplastic polymer” in the singular is used to designate either a single thermoplastic polymer or a mixture of thermoplastic polymers.

The same applies for the term “fabric”.

Unexpectedly, the inventors have thus discovered that the use on the one hand of a polymeric composition of viscosity less than or equal to 50 Pa·s and essentially or even totally constituted of one or more thermoplastic polymer(s) in the molten state, and on the other hand of a specific temperature gradient between the surface and the core of the profile during the shaping stage, makes it possible to obtain composite profiles via an injection-pultrusion method at a high production rate.

Certainly, thermoplastic polymers of low viscosity also referred to as having high fluidity and in particular of the polyamide type have already been proposed as a matrix for the formation of composite materials, in particular in the applications WO 2011/003786 A1, WO 2011/003787 A1, WO 2011/144592 A1 and WO2011/073198 A1.

However, to the knowledge of the inventors, none of the utilization technologies considered for such polymers relates to a technology of the injection-pultrusion type and still less with the specificity required according to the invention in terms of temperature gradient.

As follows in particular from the examples below, the method of the invention proves advantageous in several ways.

First of all, the utilization of thermoplastic polymers having high fluidity enables better impregnation of the reinforcing material, and thus the faster obtention of profiles further endowed with low porosity. The utilization of this type of polymer also makes it possible to produce profiles with a high content of fibers.

Further, the temperature gradient applied during the shaping of the profile between its surface and its core renders possible the production of profiles at a rate compatible with the requirements of the industry, while addressing the swelling phenomenon typically observed on articles produced by pultrusion.

Advantageously, the high pulling speed of the reinforcing material is found to be in no way prejudicial to the good use and in particular mechanical properties of the profile thus formed.

What is more, the method according to the invention makes it possible to produce a great diversity of profiles in terms of geometric sections, any, solid or hollow and from varied reinforcing fabrics such as unidirectional fibers, equilibrated or non-equilibrated fabrics, tapes, braids, or multiaxial systems (Non Crimp Fabric).

According to a preferred embodiment, the method of the invention utilizes at least one lubricating agent, particularly in stage c) and/or d).

The present invention also relates to a profile obtainable by the method according to the invention.

According to another of its aspects, a subject of the present invention is a composite article comprising a profile obtainable by the method according to the invention, characterized in that said profile is modified in its curvature by bending and/or in its profile by rotational molding.

The present invention also relates to a composite structure comprising at least two profiles obtainable by the method according to the invention, in which said profiles are assembled, in particular by welding.

Other characteristics, embodiments and advantages of the method according to the invention will better emerge from the reading of the description, the examples and the diagram which follow, given in order to illustrate and not to limit the invention.

FIG. 1 diagrammatically represents an example of an installation suitable for the implementation of an injection-pultrusion method.

In the remainder of the text, the expressions “lying between . . . and . . . ”, “ranging from . . . to . . . ” and “varying from . . . to . . . ” are equivalent and are meant to signify that the limits are included, unless otherwise stated.

Unless otherwise indicated, the expression “containing/comprising one” must be understood as “containing/comprising at least one”.

Method

As follows from the foregoing, the method according to the invention is of the injection-pultrusion type and is based in particular on the utilization of a thermoplastic polymeric composition of low viscosity to impregnate a fabric by injection, and the formation of the profile according to a continuous method from the fabric impregnated with said molten composition, with a specific thermal gradient, during the shaping stage.

In the sense of the invention, a thermoplastic polymeric composition is a composition essentially constituted, that is to say at least 85% by weight, preferably at least 95% by weight and more preferably totally of a thermoplastic polymer having high fluidity or of a mixture of at least two, at least three, or even more thermoplastic polymers having high fluidity. These polymers may be crystalline, semi-crystalline or amorphous.

A thermoplastic polymeric composition according to the invention may thus be formed of at least one semi-crystalline or amorphous polyamide or of a mixture thereof.

A thermoplastic polymeric composition may thus likewise contain one or more supplementary additives and in particular a fluidizing agent as defined below.

According to the present invention, a thermoplastic polymeric composition or a thermoplastic polymer is of high fluidity and in this respect advantageously has a viscosity less than or equal to 50 Pa·s in the molten state, in particular ranging from 1 to 30 Pa·s, preferably from 1 to 25 Pa·s.

This viscosity, in the molten state, may be measured by means of a plate-plate rheometer of diameter 50 mm, with an incremental shear scan ranging from 1 to 160 s⁻¹. The polymeric material to be assessed is in the form of granules, possibly of a film of thickness 150 μm.

Thus, when the polymeric composition according to the invention is comparable to a semi-crystalline material, it is brought to a temperature ranging from 10 to 100° C. above its melting point and the measurement is then performed.

Conversely, when the polymeric composition according to the invention is comparable to an amorphous material, it is brought to a temperature of 100 to 250° C. above the glass transition temperature, and the measurement is then performed.

As representative and non-limiting examples of such polymers, polymers obtained by polycondensation, such as polyesters, polyamides and derivatives thereof may in particular be mentioned

Quite particularly suitable for the invention are polyesters, polyamides and mixtures thereof.

It should be noted that the molecular masses stated with regard to these polymers are essentially presented to indicate a scale of weights. It should be noted that a specific molecular weight may be determined in many ways which are well known per se to those skilled in the art.

By way of illustration of these methods, those based on an analysis of the terminal groups and in particular, those making use of a gel permeation chromatography (GPC) measurement, also called steric exclusion chromatography (SEC) may in particular be mentioned. In general, the GPC measurements on a polyamide may be performed in dichloromethane (solvent and eluent), after chemical modification of the polyamide in order to solubilize it. A UV detector is utilized as the chemically modified polyamide possesses a UV chromophore. The calculation of the mass distribution and the average masses Mn and Mw may be performed in polystyrene (PST) equivalents or absolute mass, after calibration with commercial standards. If necessary, absolute mass measurements may be performed by viscosimetric detection. In the context of the present invention, the average molecular masses Mn and Mw are expressed in absolute mass. The Mn and Mw may be calculated from the totality of the distribution or after truncation of low masses if it is not desired to take into account the contribution of cyclic oligomers.

Polyesters

The semi-aromatic polyesters are preferably selected from the group constituted of the polyesters obtained by polycondensation of at least one aromatic diacid or a corresponding diester with an aliphatic, cycloaliphatic or aromatic diol.

The aromatic diacids and diesters thereof may for example be selected from terephthalic acid, dimethyl terephthalate, isophthalic acid, dimethyl isophthalate, 5-tert-butyl isophthalic acid, 4,4′-biphenyl dicarboxylic acid and the isomers of dimethyl naphthalate. The diols may be for example selected from ethylene glycol, diethylene glycol, propylene glycol, butylene glycol, isosorbide and 1,4-cyclohexane dimethanol.

The semi-aromatic polyesters having a number average molecular mass (Mn) preferably lying between 5,000 g/mol and 20,000 g/mol are particularly advantageous in view of their satisfactory mechanical properties and their behavior during various shaping processes.

The semi-crystalline polyesters are particularly preferred.

According to a particularly advantageous embodiment, the semi-aromatic polymers suitable for the invention are selected from the group constituted of polyethylene terephthalate (PET), polybutylene terephthalate (PBT), polytrimethylene terephthalate (PTT) and polyethylene naphthalate (PEN).

The PET and PBT are semi-crystalline polyesters (M.Pt. PET=245-250° C., M.Pt. PBT=225° C.).

To produce polyesters of low molecular mass, several distinct routes as follows exist. A first route consists in the direct melt synthesis of polyesters in a polycondensation reactor according to methods well known to those skilled in the art of the “direct esterification” type from diacids and diols or “transesterification” type from diesters and diols. For example for PET, the melt synthesis in reactor may be performed from terephthalic acid and ethylene glycol (direct esterification) or from dimethyl terephthalate and ethylene glycol (transesterification). Examples of synthetic processes are described in Techniques de l'ingenieur June 2004, J6488, 12 p. This route thus allows control of the molecular mass by stoppage of the polycondensation phase at a given time. A second route consists in the hydrolysis, alcoholysis, acidolysis or even aminolysis of standard polyesters. Finally, a third route, developed in particular for PBT, consists in the polymerization of cyclic CBT (cyclic butylene terephthalate) monomers for the preparation of PBT by ring opening.

The polyesters of the PET, PBT, PTT type are generally melt synthesized in a polycondensation reactor from processes referred to as direct esterification (PTA route) from terephthalic acid with an excess of glycol or transesterification (DMT route) from dimethyl terephthalate with an excess of glycol.

Polyesters having high fluidity may in particular be obtained by controlling their molecular mass during their synthesis, in particular by controlling the polymerization time, by controlling the stoichiometry of the monomers or else by addition of monomers modifying the length of the chains such as in particular monoalcohol and/or monocarboxylic acid chain limiters before or during the polymerization. It is also possible to add multifunctional compounds to the polymerization to introduce branching.

Polyesters according to the invention may also be obtained by mixing, particularly in melt, polyesters with monomers modifying the length of the chains such as in particular diols, dicarboxylic acids, monoalcohol and/or monocarboxylic acids or else with water, diamines or monoamines.

A polymeric composition of the invention may also comprise one or more copolyesters derived in particular from the above polyesters, or a mixture of these polyesters or (co)polyesters.

According to a preferred embodiment, the composition according to the invention comprises at least one polyamide or a mixture of polyamides having high fluidity and more preferably is constituted of a polyamide.

Polyamide

The polyamides considered are preferably semi-crystalline or amorphous polyamides which have a viscosity in the molten state less than or equal to 50 Pa·s, preferably ranging from 1 to 30 Pa·s.

This melt viscosity may be measured by means of a plate-plate rheometer of diameter 50 mm, with an incremental shear scan ranging from 1 to 160 s⁻¹. The polymer is formed of granules of thickness 150 μm, possibly of a film.

The polyamide, when it is semi-crystalline, is brought to a temperature ranging from 10 to 100° C. above its melting point, and the measurement is then performed.

The polyamide, when it is amorphous, is brought to a temperature of 100 to 250° C. above the glass transition temperature, and the measurement is then performed.

As polyamides having high fluidity suitable for the invention, those described in the documents WO 03/029350 A1, WO 2005/061209 A1, WO 2008/155318 A1, WO 2010/034771 A1, WO 2011/003786 A1, WO 2011/003787 A1, WO 2011/073198 A1, WO 2011/073200 A1 and WO 2011/144592 A1 may be cited.

The polyamides may in particular be semi-crystalline or amorphous. The semi-crystalline polyamides are particularly preferred.

The polyamides may in particular be selected from the group comprising the polyamides obtained by polycondensation of at least one linear aliphatic dicarboxylic acid with an aliphatic or cyclic diamine or between at least one aromatic dicarboxylic acid and an aliphatic or aromatic diamine, polyamides obtained by polycondensation of at least one amino acid or lactam with itself, or a mixture thereof and (co)polyamides.

The polyamide of the invention may in particular be selected from the group comprising polyamides obtained by polycondensation of at least one aliphatic dicarboxylic acid with an aliphatic or cyclic diamine such as PA 6.6, PA 6.10, PA 6.12, PA 12.12, PA 4.6, MXD 6 or between at least one aromatic dicarboxylic acid and an aliphatic or aromatic diamine such as the polyterephthalamides, polyisophthalamides, polyaramides, or a mixture thereof and (co)polyamides. The polyamide of the invention may also be selected from the polyamides obtained by polycondensation of at least one amino acid or lactam with itself, the amino acid being able to be generated by the hydrolytic opening of a lactam ring such as for example PA 6, PA 7, PA 10T, PA 11, PA 12, or a mixture thereof and (co)polyamides.

The copolyamides derived in particular from the above polyamides, or the mixtures of these polyamides or (co)polyamides may also be among the polyamides according to the invention. The polymerization of the polyamide of the invention is in particular performed under the standard operating conditions for polymerization of polyamides, continuously or discontinuously.

Polyamides having high fluidity may in particular be obtained according to the methods taught in the application WO 2011/073198 A1.

More particularly, polyamides having a number average molecular mass (Mn) of at least 6,000 g/mol, more preferably lying between 6,000 g/mol and 18,000 g/mol, having satisfactory mechanical properties and a certain behavior during various shaping methods, are suitable for the invention.

The polyamide of the invention, preferably semi-crystalline, may have a weight average molecular mass (Mw) lying between 6,000 g/mol and 25,000 g/mol.

Non-evolutive polyamide resins of low molecular weight, obtainable in various ways, in particular by disequilibrium of the stoichiometry of the monomers and/or addition of blocking compounds (these are monofunctional molecules also referred to as chain limiters, with a concentration of blocking terminal groups BTG) during the process of polymerization or polycondensation of the polyamides; or else by addition of monomers or blocking compounds in mixing, in particular in extrusion, may also be utilized. The weight average molecular mass Mw of these polyamide resins lies between 5,000 and 25,000 g/mol, preferably between 10,000 and 16,000 g/mol. The weight average molecular mass may be measured in accordance with the techniques cited in the application WO2011/073198 A1.

These polyamides have a concentration of terminal amine groups (TAG) and/or terminal carboxyl groups (TCG) less than or equal to 20 meq/kg.

These resins are referred to as non-evolutive inasmuch as no significant increase in their molecular mass or degree of polymerization is observed when these are utilized in the production method according to the invention; that is to say under temperature and pressure conditions normally favoring an increase in the molecular mass. This molecular mass practically does not change during the process of production of composite material profiles owing to the absence or near absence, of acidic or amine terminal groups. These resins are, in that sense, different from the partially polymerized polymers or pre-polymers traditionally used. These polyamide resins preferably have a concentration of terminal amine groups (TAG) and/or of terminal carboxyl groups (TCG) less than or equal to 20 meq/kg, preferably less than or equal to 15 meq/kg, more preferably less than or equal to 10 meq/kg, still more preferably less than or equal to 5 meq/kg, and quite particularly equal to 0 meq/kg. A polyamide suitable for the present invention may thus for example have a TAG of 0 meq/kg and a TCG of 500 meq/kg. A polyamide suitable for the present invention may thus for example have a TAG of 400 meq/kg and a TCG of 0 meq/kg. A polyamide having a concentration of terminal amine groups (TAG) less than or equal to 5 meq/kg generally has a concentration of terminal carboxyl groups (TCG) lying between 100 and 1,000 meq/kg. A polyamide having a concentration of terminal carboxyl groups (TCG) less than or equal to 5 meq/kg generally has a concentration of terminal amine groups (TAG) lying between 100 and 1,000 meq/kg.

Finally, a polyamide of the invention may also have a TAG=400 meq/kg, a TCG of 0 meq/kg and a concentration of blocking terminal groups BTG=100 meq/kg.

The quantities of terminal amine groups (TAG) and/or acid groups (TCG) may be determined by potentiometric titration after complete dissolution of the polyamide, for example in trifluoroethanol, and addition of a strong base in excess. The basic species are then titrated with an aqueous solution of strong acid.

Such resins according to the invention may be produced in many ways and are well known per se to those skilled in the art.

For example, such resins may be produced by addition during polymerization, in particular at the start, in the course of or at the end of the polymerization, of monomers of the polyamide, in the further presence of bifunctional and/or monofunctional compounds. These bifunctional and/or monofunctional compounds have amine or carboxylic acid functions capable of reacting with the monomers of the polyamide and are utilized in proportions such that the resulting polyamide resin preferably has a TAG and/or TCG less than 20 meq/kg. It is also possible to mix bifunctional and/or monofunctional compounds with a polyamide, in particular by extrusion, generally a reactive extrusion, in such a manner as to obtain the polyamide resin utilized according to the present invention. Any type of mono- or dicarboxylic acid, aliphatic or aromatic, or any types of mono- or diamines, aliphatic or aromatic, may be utilized. In particular, n-dodecylamine and 4-amino-2,2,6,6-tetramethylpiperidine, acetic acid, lauric acid, benzylamine, benzoic acid, and propionic acid, may be utilized as the monofunctional compound. In particular, adipic acid, terephthalic acid, isophthalic acid, sebacic acid, azelaic acid, dodecanedioic acid, decanedioic acid, pimelic acid, suberic acid, dimers of fatty acids, di-(carboxyethyl) cyclohexanone, hexamethylene diamine, methyl-5 pentamethylene diamine, metaxylylene diamine, butanediamine, isophorone diamine, 1,4 diamino cyclohexane and 3,3′,5-trimethyl hexamethylenediamine may be utilized as the bifunctional compound. An excess of adipic acid or an excess of hexamethylene diamine may also be utilized for the production of a polyamide of the 66 type have a high melt fluidity and a concentration of terminal amine groups (TAG) and/or terminal carboxyl groups (TCG) preferably less than 20 meq/kg.

It is also possible to markedly decrease the concentrations of acidic or amine terminal groups of a polyamide by running a finishing step under vacuum at the end of polymerization such as to eliminate the water in order to consume all or practically all the terminal groups, and thus to guarantee that the resin will no longer evolve in the sense of increase in the molecular mass whatever the conditions of utilization of the profile may be, in particular under pressure or under vacuum.

Blocked, non-evolutive polyamide resins of low molecular mass having a number average molecular mass Mn less than 8,000 g/mol and/or having a concentration of terminal amine groups (TAG) greater than 25 meq/kg, a concentration of terminal acid groups (TCG) greater than 25 meq/kg and a concentration of blocked terminal groups (BTG) comprised according to the formula 2000000/(TAG+TCG+BTG)<8,000 g/mol may also be utilized in the method of the present invention. These polyamides may in particular be produced by addition of various mono- or bi-functional monomers during polymerization of the polyamide.

A star polyamide comprising star macromolecular and if applicable linear macromolecular chains may also be utilized as a polyamide having high fluidity.

The polyamide with star structure is a polymer comprising star macromolecular chains and possibly linear macromolecular chains. Polymers comprising such star macromolecular chains are for example described in the documents FR2743077, FR2779730, EP0682057 and EP0832149.

These compounds are known to have improved fluidity in comparison to linear polyamides. Star macromolecular chains comprise a core and at least three polyamide branches. The branches are bound to the core by a covalent bond, via an amide group or a group of another nature. The core is an organic or organometallic chemical compound, preferably a hydrocarbon compound possibly comprising hetero atoms and to which the branches are bound. The branches are polyamide chains. The polyamide chains constituting the branches are preferably of the type of those obtained by polymerization of lactams or amino acids, for example of the polyamide 6 type. The polyamide with star structure according to the invention possibly comprises, as well as the star chains, linear polyamide chains. In that case, the ratio by weight between the quantity of star chains and the sum of the quantities of star chains and linear chains lies between 0.5 and 1 inclusive. It preferably lies between 0.6 and 0.9.

According to a preferred embodiment of the invention, the polyamide with star structure, that is to say comprising star molecular chains, is obtained by copolymerization of a mixture of monomers comprising at least:

a) monomers of the following general formula I):

R₁A-Z]ₘ (I)

b) monomers of the following general formulae (Ma) and (Mb):

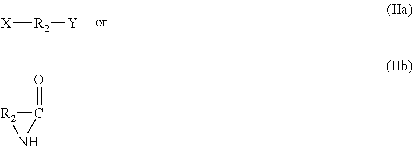

c) possibly monomers of the following general formula (III):

Z—R₃—Z (III)

in which:
R₁ is a linear or cyclic, aromatic or aliphatic hydrocarbon radical comprising at least 2 atoms of carbon, and possibly comprising hetero atoms;
A is a covalent bond or an aliphatic hydrocarbon radical possibly comprising hetero atoms and comprising from 1 to 20 atoms of carbon;
Z represents a primary amine function or a carboxylic acid function;
Y is a primary amine function when X represents a carboxylic acid function, or Y is a carboxylic acid function when X represents a primary amine function;
R₂, R₃, identical or different, represent substituted or unsubstituted aliphatic, cycloaliphatic or aromatic hydrocarbon radicals comprising from 2 to 20 atoms of carbon and possible comprising hetero atoms; and
m represents a whole number lying between 3 and 8.

Carboxylic acid is understood to mean carboxylic acids and derivatives thereof, such as acid anhydrides, acid chlorides or esters.

Methods for obtention of these star polyamides are described in the documents FR2743077 and FR2779730. These methods lead to the formation of star macromolecular chains, possibly mixed with linear macromolecular chains. If a comonomer of formula (III) is used, the polymerization reaction is advantageously performed until the attainment of thermodynamic equilibrium.

The monomer of formula (I) may also be mixed with a molten polymer, in the course of an extrusion operation.

Thus, according to another embodiment of the invention, the polyamide with star structure is obtained by mixing in melt, for example by means of an extrusion device, a polyamide of the type of those obtained by polymerization of lactams and/or amino acids and a monomer of formula (I). Such obtention methods are described in the patents EP0682070 and EP0672703.

According to a particular characteristic of the invention, the radical R₁ is either a cycloaliphatic radical such as the tetravalent radical of cyclohexanonyl, or a 1,1,1-triyl-propane or 1,2,3-triyl-propane radical. As other radicals R₁ suitable for the invention, by way of example the trivalent radicals of substituted or unsubstituted phenyl and cyclohexanyl, the tetravalent radicals of diaminopolymethylene with a number of methylene groups advantageously lying between 2 and 12 such as the radical deriving from EDTA (ethylenediaminetetraacetic acid), the octavalent radicals of cyclohexanonyl or cyclohexadinonyl, and the radicals deriving from compounds resulting from the reaction of polyols such as glycol, pentaerythritol, sorbitol or mannitol with acrylonitrile may be mentioned.

Advantageously, at least two different radicals R₂ may be employed in the monomers of formula (II).

The radical A is, preferably, a methylene or polymethylene radical such as the ethyl, propyl or butyl radicals or a polyoxyalkylene radical such as the polyoxyethylene radical.

According to a particular embodiment of the invention, the number m is greater than or equal to 3 and advantageously equal to 3 or 4. The reactive function of the multifunctional compound represented by the symbol Z is a function capable of forming an amide function.

Preferably, the compound of formula (I) is selected from 2,2,6,6-tetra-(β-carboxyethyl)-cyclohexanone, trimesic acid, 2,4,6-tri-(aminocaproic acid)-1,3,5-triazine and 4-aminoethyl-1,8-octanediamine.

The mixture of monomers from which the star macromolecular chains are derived may comprise other compounds, such as chain limiters, catalysts, and additives such as light stabilizers or heat stabilizers.

The polyamide of the invention may also comprise hydroxyaromatic moieties chemically bound to the chain of the polyamide. To do this, a hydroxyaromatic organic compound is utilized which is a compound comprising at least one aromatic hydroxyl group and at least one function capable of binding chemically to the acidic or amine functions of the polyamide, which once chemically bound to the polyamide chain becomes a hydroxyaromatic moiety. This compound is preferably selected from the group comprising: 2-hydroxyterephthalic acid, 5-hydroxyisophthalic acid, 4-hydroxyisophthalic acid, 2,5-dihydroxyterephthalic acid, 4-hydroxyphenylacetic acid or gallic acid, L-tyrosine, 4-hydroxyphenylacetic acid, 3,5-diaminophenol, 5-hydroxy m-xylylene diamine, 3-amino-phenol, 3-amino-4-methyl-phenol, and 3-hydroxy-5-amino-benzoic acid.

Fabric (Reinforcement)

As previously stated, the method according to the invention utilizes at least one reinforcing fabric.

“Fabric” is understood to mean a textile area obtained by assembly of threads or fibers joined together by any method, such as in particular gluing, felting, braiding, weaving or knitting. These fabrics are also referred to as fibrous or filamentous networks. Thread is understood to mean a monofilament, a continuous multifilament thread, or a spun yarn, obtained from a single type of fibers or from several types of fibers intimately mixed. The continuous thread may also be obtained by assembly of several multifilament threads. Fiber is understood to mean a filament or a set of cut, cracked or converted filaments. The reinforcing threads and/or fibers according to the invention are preferably selected from threads and/or fibers of carbon, glass, aramides, polyimides, flax, hemp, sisal, coir, jute, kenaf, bamboo and/or a mixture thereof. More preferably, the reinforcing fabrics are solely constituted of reinforcing threads and/or fibers selected from threads and/or fibers of carbon, glass, aramides, polyimides, flax, hemp, sisal, coir, jute, kenaf, bamboo and/or a mixture thereof, in particular, the reinforcing fabrics are constituted solely of glass fibers.

These fabrics preferably have a grammage, that is to say the weight per square meter, lying between 100 and 1,200 g/m², more preferably lying between 100 and 1,000 g/m².

Their structure may be random, unidirectional (1D), or multidirectional (2D, 2,5D, 3D or other).

In particular, these fabrics may be selected from unidirectional fibers, equilibrated or non-equilibrated fabrics, tapes, braids, non crimp fabric and mixtures thereof.

Preferably, they are in tape form.

They may also be utilized folded, that is to say in the form of a tape obtained by the superposition of several folds of this fabric, in order to obtain profiles having a high proportion of fibers.

The reinforcing fabrics may be preshaped in particular utilizing a thermosetting or thermoplastic based binder.

In order to facilitate the impregnation it may be useful to utilize drainage fabrics in the reinforcing fabric which will facilitate the flow of the resin.

The polymeric composition and the reinforcing fabric as described above are utilized for the production of a profile according to an injection-pultrusion method.

In the method according to the invention, the transformation of the fabric into composite profile is ensured in continuous mode via a pulling system which makes it possible to cause the fabric to move at the desired speed through the injection-pultrusion device.

In fact, this apparatus, for example of the caterpillar type maintains the whole of the fabric under traction from the start to the end of the process.

Thus, the reinforcing fabric is continuously pulled with a pulling speed of at least 0.4 m·min⁻¹ in the course of the process, preferably ranging from 0.4 to 12 m·min⁻¹, in particular, from 0.5 to 8 m·min⁻¹ by means of a pulling apparatus positioned downstream of the channel devoted to the shaping stage.

It is for the skilled person to adjust the pulling speed in such a manner that it is compatible with good impregnation of the fabric, with regard in particular to the characteristics of the polymeric composition or the fabric utilized, the injection rate of the polymeric composition, or again the desired geometry of the profile to be produced.

As mentioned above, the technique of production by injection-pultrusion according to the invention requires at least the following stages c) and d):

c) impregnation of a fabric by injection of the molten polymeric composition,

and

d) shaping of the impregnated fabric to form the profile.

The implementation of the two stages of impregnation and shaping may be ensured by means of several modifications of devices.

According to a first embodiment, these two stages may be implemented in a common channel.

According to this alternative, the common channel may comprise successively at least one hot entry zone, a hot impregnation zone equipped with an injection chamber, a thermal control zone, and a shaping zone where the profile is cooled in a controlled manner. This channel is generally advantageously equipped with a vent, for example positioned in a zone at atmospheric pressure, directly downstream of the impregnation zone, and/or upstream of the thermal control zone, devoted to elimination of occluded gaseous residues or air.

FIG. 1 summarizes a device utilizing such a single channel.

According to a second embodiment, the two stages may be implemented in two distinct and consecutive channels, whether or not spaced apart.

According to this alternative, the first channel may successively comprise at least one hot entry zone and one hot impregnation zone equipped with an injection chamber, and the second channel may comprise a shaping zone, said first channel being if appropriate equipped with a vent directly downstream of the impregnation zone, devoted to elimination of occluded gaseous residues or air.

According to another alternative of this second embodiment, the second channel is constituted of a calendering machine or of a train of several calendering machines at controlled temperature.

Impregnation Stage c)

This impregnation stage c) is performed on a fabric having a temperature less than 400° C. preferably 350° C., and greater than or equal to the temperature of said polymeric composition in the molten state.

During this stage, the reinforcing fabric is generally at a temperature ranging from 200 to 380° C.

Whatever the arrangement of the device, the fabric must be brought to the required temperature before the impregnation stage. The implementation of this heating falls within the competence of the skilled person, and may be effected in the hot entry zone of the channel devoted to the impregnation.

The fabric may also be preheated prior to stage b), in particular in a preheating oven, at a temperature ranging from 150 to 350° C.

The impregnation stage c) is performed by injection of the molten polymeric composition through the fabric positioned in the impregnation zone.

Preferably, the impregnation is total, which signifies that no zone of fabric remains non-impregnated with the polymeric composition.

To do this, the polymeric composition may be injected from an injection chamber connected to the channel zone devoted to the impregnation of said fabric.

This injection may for example be performed by means of an extruder, preferably a double screw extruder, or else by means of a recirculation pump.

In general, the polymeric composition is introduced into the inlet of the extruder and is heated there such that on emergence from the extruder it is in the molten state and at a viscosity less than or equal to 50 Pa·s.

It is for the skilled person to adjust the temperature, the flow rate and injection pressure of the polymeric composition in such a manner that they are compatible with good impregnation of the fabric, with regard in particular to the characteristics of the polymeric composition or of the fabric utilized, the pulling speed or also the desired geometry of the profile to be produced.

As regards the injection temperature, the polymeric composition is preferably heated during its passage in the extruder, such that on emergence from therefrom it is injected through the fabric at a temperature of the same order as that of the fabric during this stage.

Thus, the polymeric composition is preferably injected at a temperature less than 380° C., and greater by at least 10° C. than the melting point of said polymeric composition if comparable to a semi-crystalline material and greater by at least 100° C. than the glass transition temperature of said polymeric composition if comparable to an amorphous material.

It is therefore generally at a temperature ranging from 200 to 380° C. during its injection.

As regards the injection rate, this is preferably adjusted to produce profiles comprising a volume of polymeric composition ranging from 25 to 65% relative to the total volume of the profile.

As for the pressure, the polymeric composition may advantageously be injected through the fabric at a pressure ranging from 0.1 to 20 bars, preferably from 0.2 to 12 bars, in particular from 0.5 to 10 bars.

Apart from the adjustment of the temperature, and the rate and pressure of injection of the polymeric composition, the rapid and total impregnation of the fabric may be facilitated by a geometric profile of the channel with reduction of width (angle) and/or systems of the bar feed or baffle type.

According to a particular embodiment, the impregnated fabric, following the impregnation stage c), and prior to the shaping stage d), may undergo a temperature stabilization stage c′), in which the fabric impregnated with the polymeric composition in the molten state is brought to a temperature remaining less than 380° C. and greater by at least 10° C. than the melting point of said polymeric composition if comparable to a semi-crystalline material and greater by at least 100° C. than the glass transition temperature of said polymeric composition if comparable to an amorphous material.

In the modification of a device with two channels, this stage will be performed within the channel referred to as hot.

Likewise, the method may comprise a preliminary stage of shaping the fabric impregnated with polymer according to a defined geometric profile, taking place before the shaping stage d).

Stage d) of Shaping the Impregnated Fabric to Form the Profile

As previously stated, the profile is shaped in stage d) with a thermal profile such that:
its surface temperature is less than the crystallization temperature of the polymeric composition if semi-crystalline and less than 60° C. beyond the glass transition temperature of the polymeric composition (Tg) if amorphous, and
its core temperature is greater than the crystallization temperature of the polymeric composition if semi-crystalline, and greater than 60° C. beyond the glass transition temperature of the polymeric composition (Tg) if amorphous.

Advantageously, when the polymeric composition is semi-crystalline, the profile is shaped with a thermal profile such that its core temperature is less than the melting temperature of said polymeric composition.

According to a preferred embodiment, the thermal profile required in stage c) for said fabric to be shaped is adjusted on exit from stabilization stage b′) if existing.

In a pultrusion-injection device, utilizing for the shaping stage d) a channel distinct from the channel considered for the impregnation, this thermal profile may be adjusted before entry into the channel devoted to shaping and advantageously in the space provided between the two channels and which then features a thermal control zone. This thermal control zone is advantageously endowed with a temperature less than the temperature of the first channel, in particular by means of a thermal insulation and/or external cooling device.

In particular, this mode of cooling is quite particularly advantageous when the dimensions of the pultruded object are substantial, of the thick plate or large cross-section profile type for example, but also when the pulling speed is high, for example greater than 1 m/min.

Advantageously, such a device may be in the form of a spray vaporizing an aqueous solution.

When this type of cooling device is utilized, the thermal control zone is preferably open to the air, such that the aqueous spray is vaporized directly onto the material to be shaped.

It is for the skilled person to adjust the flow rate and the vaporization temperature of the cooling spray, in particular with regard to the dimensions of the profile to be produced, the length of the thermal control zone, the temperature of the material to be shaped on exit from the first channel, and the desired temperature at the surface and in the core of that material in order to perform the shaping stage.

Additive

According to one embodiment, the method of the invention utilizes at least one additive usually introduced into materials based on thermoplastic polymer.

Thus, as examples of additives, heat stabilizers, UV stabilizers, antioxidants, lubricants, pigments, dyes, plasticizers, reinforcing fillers, flame retardants and impact resistance modifiers may be cited, and in particular a lubricating agent.

In particular, the method utilizes at least one lubricating additive, particularly in stage c) and/or d).

Thus, the utilization of a lubricating agent is particularly advantageous inasmuch as such an additive makes it possible to increase the reduction in friction between the profile and the wall of the channel during the shaping stage. The reinforcing fabric pulling force is thus more constant and lower.

Preferably such a lubricating agent is selected from polymer production auxiliary agents such as polyvinylidene fluoride or polytetrafluoroethylene, plasticizers such as oligomers of cyclic ester(s), mineral fillers known for their lubricating or anti-adhesion properties such as talc, mica, and graphite, as well as mixtures thereof, in particular graphite.

The utilization of a lubricating agent, in particular as defined above, may be effected in several zones of the method.

Thus, according to a first embodiment, it is present in combination with the thermoplastic polymers forming the molten polymeric composition devoted to the impregnation of the fabric, in the impregnation zone.

According to this embodiment, the lubricating agent may for example be mixed with the thermoplastic polymer or polymers concerned at the extruder, prior to its injection through the fabric.

Still according to this embodiment, the lubricating agent and the thermoplastic polymer compound(s) may be utilized in a weight ratio of lubricating agent/polyamide ranging from 0.1/99.9 to 10/90, preferably from 0.5/99.5 to 5/95.

According to a second embodiment, the lubricating agent may be utilized in the space provided between the two channels, in the specific case of an installation with two channels.

In particular, it may be present in an aqueous solution used as an external cooling device.

Finally, according to a third embodiment, the lubricating agent may be introduced in the liquid state into the shaping zone, whatever the arrangement of the injection-pultrusion installation.

It is then injected directly within the shaping zone via one or more injection point(s) positioned in this zone.

In this third embodiment, relating to the utilization of an additive during the shaping stage, this agent, apart from those mentioned above, may be a thermoplastic polymer in the liquid state, having a melting point lower than the crystallization temperature of the thermoplastic polymers or polymers utilized for the impregnation and to produce the profile.

The lubricating effect of such a polymer is ensured by the fact that it is in the liquid state, contrary to the surface of the profile during the shaping stage.

Furthermore, beyond its lubricating action, such a polymer may confer surface characteristics onto the profile such as for example surface hydrophobicity, a specific texture facilitating the welding of the profile, a defined surface state or a particular color.

Such characteristics may be procured through the polymer itself or else by fillers and/or additives, such as pigments or conducting fillers, formulated with the polymer injected.

This polymer may be semi-crystalline or amorphous, and advantageously exhibits a minimum of compatibility with the thermoplastic polymer or polymers constituting the profile, in such a manner as not to impair the shaping of the profile.

Thus, the preferred polymers have a low melting point, that is to say ranging from 100 to 220° C. and/or are functionalized with maleic anhydride or another compatibilizing agent.

Profile

As previously stated, according to another of its aspects, the present invention relates to a profile obtainable by the method according to the invention.

The profile obtained on emergence from the shaping stage d) has, throughout its thickness, a temperature lower than the crystallization temperature of the thermoplastic polymeric composition if semi-crystalline, and less than 60° C. beyond the glass transition temperature of the thermoplastic polymeric composition if amorphous.

Generally, this shaping stage d) is followed by a cooling stage in which the profile is cooled throughout its thickness to a temperature ranging from 150° C. to 50° C. This stage may be performed by any method known to those skilled in the art.

The profile obtained on emergence from the shaping stage d) or at the end of the method of the invention may in particular comprise a volume of reinforcing fabric ranging from 35 to 75%, in particular ranging from 50 to 63%, relative to the total volume of the profile.

Its cross-section may be solid or hollow, and with simple or complex geometry. For this reason, the shaping zone according to the single channel alternative, or the channel devoted to the shaping, possesses a geometry adjusted for obtaining the expected profile.

For example, a profile with a simple cross-section, of the rectangular type, may have a width ranging up to 2 m, or even 2.56 m (100 inches), and a minimum thickness of 0.2 mm ranging up to 10 mm, or even 15 mm or 25 mm (1 inch).

Cross-sections with complex geometries may in particular be square, or else U or I-shaped (for example a normal IPN profile), of the omega type or again any type of geometry.

As profiles of hollow cross-section, profiles of the circular or rectangular tube type feature in particular.

The invention also relates to a profile with a thermoplastic polymeric matrix comprising a volume of reinforcing fabric ranging from 35 to 75%, in particular ranging from 50 to 63%, relative to the total volume of the profile, in order to obtain high mechanical performance.

According to yet another of its aspects, a subject of the present invention is a composite article comprising at least one profile obtainable by the method according to the invention, characterized in that the curvature of said profile is modified by bending and/or its profile by rotational molding.

The present invention also relates to a composite structure comprising at least two profiles obtainable by the method of the invention, in which said profiles are assembled, in particular by welding.

Applications

The profiles according to the invention may be used in many fields such as the aerospace, automotive, and energy industries, civil engineering or agricultural machinery, and the sport and leisure industry. These structures may be utilized to produce sports articles, reinforcing structures (chassis) or else to produce various surfaces such as special floors, partitions, vehicle coachwork components, or panels. In the aerospace industry, these structures are in particular utilized in fairings (fuselage, wing, tail-plane). In the automotive industry, they are utilized for example in chassis, floors, bumpers or supports such as the front units or the rear units.

The examples and the FIGURE which follow are in order to illustrate, and not to limit, the scope of the invention.

Equipment and Methods

In the examples which follow, the continuous production method of a profile by pultrusion is implemented by means of a pultrusion installation 10 as illustrated in FIG. 1.

The injection-pultrusion installation 10 illustrated first of all comprises creels 12 holding rolls or bobbins of reinforcing fabric 14 to be impregnated with a polymeric matrix and to be shaped according to the desired profile geometry.

The reinforcing fabrics are tensioned and pulled through the injection-pultrusion installation 10 by a pulling device 16, here of the caterpillar type. The speed of the reinforcing fabrics through the injection-pultrusion installation is greater than 0.4 m/min, preferably lying between 0.8 and 8 m/min.

Through the injection-pultrusion installation, the reinforcing fabrics 14 are firstly guided by a guiding device 18, to position them relative to one another, in particular to superpose them.

The reinforcing fabrics 14 next pass through a preheating oven 22 devoted to heating the reinforcing fabric, then a channel 20.

This channel 20 firstly comprises a hot entry zone 24, in which the fabrics are brought to the temperature required to perform the impregnation stage, for example by means of an oven, then a hot impregnation zone equipped with an injection chamber 25 in which the reinforcing fabrics 14, hot, are impregnated with a molten polymer. To do this, the polymer is injected into the injection chamber 25 under low pressure, typically less than 20 bars. This injection under low pressure may for example be effected by means of an extruder 26 possibly with a recirculation pump. The extruder 26 may for example be a double screw extruder, in particular when the polymer with which it is desired to impregnate the reinforcing fabrics is a thermoplastic polymer in the form of granules (compound) or powder, the system having to deliver the quantity of polymer suitable for the complete impregnation of the reinforcing material, and that for the pulling speeds utilized. The pressure/flow rate regulation at the injection of thermoplastic polymer is performed by the various techniques known to those skilled in the art in the form of metering devices or pumps.

The channel 20 next comprises a thermal control zone 28 in which the impregnated reinforcing fabrics 14 are cooled and possibly reshaped so as to pass from a flat section to 3D geometry, so that the profile may be shaped according to the thermal gradient required in stage d), then finally a shaping zone 29 having the geometry corresponding to that desired for the cross-section of the profile 30. The profile 30 may then be cut to the desired length downstream of the pulling device 16 by any appropriate cutting means, such as a saw for example.

The channel 20 may be provided with vents downstream of the impregnation zone, and upstream of the thermal control zone, devoted to the elimination of occluded gaseous residues or air.

Furthermore, in place of a unique channel 20 as previously described, the injection-pultrusion installation 10 may comprise several channels, in particular a so-called “hot” channel, in which the reinforcing fabrics 14 are heated and impregnated with injected molten polymer, and a so-called “cold” channel, or else a calendering train, where the reinforcing fabrics thus impregnated are shaped. Between the two channels, a space featuring a thermal control zone may be provided, making it possible to obtain the thermal profile required for shaping the profile.

More precisely, in the examples which follow, the method for production of a profile is performed by means of a Pultrex injection-pultrusion installation 10 comprising:
a preheating oven of length 2 m 50, temperature-regulated at 300° C. (SAT),
a regulated pulling device (PULTREX),
a Leistritz 18D double screw extruder, and
a channel designed for obtention of a profile of cross-section 50*4 mm² constituted of a zone of 100 mm for arrival and reheating of the reinforcing material, a zone of 310 mm up to the point of injection of the molten polymer, then a beveled zone of 365 mm, an intermediate zone and a shaping zone of 250 mm.

NB: in the case of the production of a profile of complex cross-section, the intermediate zone is then a zone of alteration from flat shape final geometry.

In the following examples, this method utilizes a tape of grammage 800 g/m² (equilibrated 0/90) having a width of 50 mm, (Reference: UDV 12.45 10/800/0-50, ATG) of glass fibers, as the reinforcing fabric. Seven folds of tape are utilized in order to obtain a volume ratio of fibers of about 50%, and the tape is continuously pulled in the course of the process with a pulling speed of 0.7 m·min⁻¹.

The injection conditions at the extruder are regulated so as to feed the channel at 80 g/min (4.8 kg/h).

The temperature at the shaping stage is regulated so as to have a surface temperature of the profile lower than the melting point (for polyamide PA66: T<260° C.), and preferably lower than the crystallization point, while maintaining a sufficient core temperature in the profile (T greater than the crystallization temperature Tc, i.e. for polyamide PA66 220° C.). The temperature profile was verified during a specific test by introduction of a thermocouple within the profile.

### EXAMPLE 1: EFFECT OF THE TEMPERATURE GRADIENT REQUIRED ACCORDING TO THE INVENTION

A method for continuous production of a profile by pultrusion is performed by means of the device described above utilizing the polyamide A, namely the PA66 available from SOLVAY. This polyamide has a melting point of 260° C., a crystallization temperature of 220° C., and a melt viscosity less than 20 Pa·s at a temperature of 285° C. with a shear rate of 10 s⁻¹.

In the hot entry zone, the tape is brought to the desired temperature for performing the impregnation stage, namely 300° C.

It is maintained at that temperature until total impregnation of the fabric.

In the impregnation zone, the polyamide A is injected at a temperature of 290° C.

In a first test, referred to as the control, the impregnated fabric then enters a thermal control zone on emergence from which its surface temperature is reduced to a temperature greater than the crystallization temperature of the polyamide utilized (220° C.) and its core temperature remains at a higher temperature close to the melting point of this polyamide (260° C.). In the shaping zone, the surface temperature is greater than the crystallization temperature of the polyamide, and the core temperature is higher (close to the melting point).

In a second test, according to the invention, the impregnated fabric then enters a thermal control zone on emergence from which its surface temperature is adjusted to a temperature less than the crystallization temperature of the polyamide utilized, and its core temperature is adjusted to about 250° C. i.e. lower than the melting point of this polyamide but above the crystallization point. In the shaping zone, the surface temperature is less than the crystallization temperature of the polyamide, and the core temperature remains higher (close to the melting point).

The profiles obtained have a volume ratio of fibers of 50% calculated initially and confirmed by mass loss after high temperature calcination.

The swell ratio of the profile is determined by means of the following relationship:

Swell ratio(in %)=(difference between the thickness of the final profile and the thickness of the channel)/(thickness of the channel)*100

| | Surface temperature of the | |
|---|---|---|
| | profile during the shaping | Swell |
| Polyamide concerned | stage | ratio (in %) |
| Polyamide A having a | 250° C. | 20 |
| crystallization temperature of | less than 220° C. | 0 to 2.5 |
| 220° C. | | |

It is found that the profiles obtained according to the method according to the invention, that is to say those which are shaped with a temperature profile such that their surface temperature is less than the crystallization temperature of the polyamide utilized, have a low or even negligible swell ratio, lying between 0 and 5%.

Conversely, when the shaping stage is performed on an impregnated fabric having a surface temperature greater than the crystallization temperature of the polyamide utilized (and therefore higher in the core), a swelling phenomenon is observed due to the relaxation of the folds coated with polyamide after passage through the channel.

This swelling leads to an increment in the thickness of the profile, and may moreover generate substantial inter-fold porosity (cavities).

### EXAMPLE 2: EFFECT OF THE VISCOSITY OF THE POLYAMIDE

A method for continuous production of a profile by pultrusion is performed by means of the device described above utilizing either polyamide B or the polyamide C, both belonging to the Technyl® PA66 range marketed by SOLVAY.

These two polyamides have the same melting point, namely 260° C., a relatively similar crystallization temperature (around 220° C.), and a different viscosity in the molten state, according or not according to the present invention.

The polyamide B, not formulated, referred to as control, has a melt viscosity from 60 to 70 Pa·s, and the polyamide C, according to the invention, has a melt viscosity from 15 to 20 Pa·s.

For these two polyamides, the viscosity was measured at a temperature of 275° C. and at 10 s⁻¹.

In the hot entry zone, the tape is brought to the desired temperature for performing the impregnation stage, namely 290° C.

It is maintained at this temperature until total impregnation of the fabric.

In the impregnation zone, the polyamide B or the polyamide C is injected at a temperature of 290° C.

The impregnated fabric then enters a thermal control zone on emergence from which its surface temperature is adjusted to a temperature less than 220° C. and its core temperature is adjusted to an intermediate temperature between the crystallization and the melting temperature of the polyamide utilized, typically 250° C.

The profiles obtained have a volume ratio of fibers of 50%, calculated initially and confirmed by mass loss after high temperature calcination.

The void ratio (in %) is measured by weighing (Standard ASTM D2734-94), and possibly by scanning electron microscopy (SEM). The impregnation ratio is then calculated according to the following relationship: impregnation ratio (in %)=100−void ratio (in %).

| | Melt viscosity of the | |
|---|---|---|
| | polyamide (at 275° C. and | Impregnation |
| Polyamide concerned | at 10 s⁻¹) (in Pa · s) | ratio (in %) |
| Polyamide B (control) | 60 to 70 | 60 to 90 |
| Polyamide C (according to the | 15 to 20 | 95 to 99 |
| invention) | | |

Thus, for a pulling speed of 0.7 m/min and a volume ratio of fibers of 50%, the impregnation ratio is much higher with a polyamide according to the invention, compared to a polyamide having a viscosity greater than 50 Pa·s.

### EXAMPLE 3: EFFECT OF THE ADDITION OF A LUBRICATING ADDITIVE

A method for continuous production of a profile by pultrusion is performed by means of the device described above utilizing either the polyamide C of example 2, or the polyamide D.

The polyamide D comprises 98% by weight of polyamide C, and 2% by weight of Graphite (Timcal SFG6) of average grain size 6 microns.

It has the same melting and crystallization temperatures as polyamide C. It has a melt viscosity from 20 to 25 Pa·s at a temperature of 275° C. and at 10 s⁻¹.

In the hot entry zone, the tape is brought to the desired temperature for performing the impregnation stage, namely 290° C. It is maintained at this temperature until total impregnation of the fabric.

In the impregnation zone, the polyamide C or polyamide D is injected at a temperature of 290° C.

The impregnated fabric then enters a thermal control zone on emergence from which its surface temperature is adjusted to a temperature less than the crystallization temperature of the polyamide utilized, and its core temperature is adjusted to a higher temperature, close to the melting point of the polyamide, typically towards 250° C.

The pulling force is appreciably decreased: typically, it changes from a level of 7 to 10 kN to less than 3 kN.

The profiles obtained have a volume ratio of fibers of 50% calculated initially and confirmed by measurement of mass loss after calcination.

This example highlights the fact that the utilization of the polyamide with a lubricating agent makes it possible to advantageously improve the stability of the profile production method.

Indeed, when the polyamide utilized is the polyamide D, it is possible to produce more than 200 m of profile continuously in a stable manner with a constant pulling force, less than 5 kN. The profile obtained has a beautiful appearance, with controlled geometry.

1. A method for continuous production of a composite material profile by injection-pultrusion from at least one reinforcing fabric and at least one thermoplastic polymer, said method comprising:
a) supplying a thermoplastic polymeric composition of viscosity less than or equal to 50 Pa·s and based on one or more thermoplastic polymers in the molten state and,
b) supplying a reinforcing fabric at a temperature less than 400° C., and greater than or equal to the temperature of said polymeric composition in the molten state,
c) impregnating said fabric with said polymeric composition;
d) shaping said fabric impregnated with said polymeric composition to form a shaped composite material with a profile, wherein
i) said fabric is continuously pulled with a pulling speed of at least 0.4 m·min⁻¹ in the course of said process;
ii) the impregnation stage c) is performed by injection of said polymeric composition in the molten state through the fabric;
iii) the profile is shaped in stage d) with a thermal profile such that:
its surface temperature is less than the crystallization temperature of said polymeric composition if semi-crystalline and less than 125° C. above the glass transition temperature (Tg) of said polymeric composition if amorphous, and
its core temperature is greater than the crystallization temperature of said polymeric composition if semi-crystalline and higher than 50° C. above the glass transition temperature (Tg) of said polymeric composition if amorphous.

2. The method as claimed in claim 1, further comprising a cooling stage following the shaping stage d), in which said profile is cooled throughout its thickness at a temperature ranging from 150° C. to 50° C.

3. The method as claimed in claim 1, in which said fabric is continuously pulled with a pulling speed ranging from 0.4 to 12 m·min⁻¹ by means of a pulling apparatus positioned downstream of the channel devoted to the shaping stage.

4. The method as claimed in claim 1, in which said polymeric composition utilized at c) has in the molten state a viscosity ranging from 1 to 30 Pa·s.

5. The method as claimed in claim 1, in which said polymeric composition is formed of at least one semi-crystalline or amorphous polyamide or of a mixture thereof.

6. The method as claimed in claim 5, in which said polyamide is semi-crystalline and has a weight average molecular weight Mw lying between 6,000 and 25,000 g/mol.

7. The method as claimed in claim 1, in which the impregnation stage c) and shaping stage d) proceed in a common channel comprising successively a hot entry zone, a hot impregnation zone having an injection chamber, a thermal control zone, and a shaping zone, optionally, said channel being provided with a vent, devoted to the elimination of gaseous residues or air.

8. The method as claimed in claim 1, in which the impregnation stage c) and shaping stage d) proceed in two distinct and consecutive channels, the first channel comprising successively a hot entry zone and a hot impregnation zone having an injection chamber, the second channel comprising a shaping zone, optionally, said first channel being provided with a vent, devoted to the elimination of gaseous residues or air.

9. The method as claimed in claim 1, in which the impregnation stage c) and shaping stage d) proceed in two distinct and consecutive channels, the first channel comprising successively a hot entry zone and a hot impregnation zone having an injection chamber, said first channel being provided with a vent, devoted to the elimination of gaseous residues or air, the second channel comprising a calendering machine or a train of several calendering machines at controlled temperature.

10. The method as claimed in claim 1, further comprising a temperature stabilization stage c′) following the impregnation stage c) and before the shaping stage d), in which said fabric impregnated with the polymeric composition in the molten state is brought to a temperature less than 380° C. and greater by at least 10° C. than the melting point of said polymeric composition if comparable to a semi-crystalline material and greater by at least 100° C. than the glass transition temperature of said polymeric composition if comparable to an amorphous material.

11. The method as claimed in claim 1, further utilizing at least one lubricating agent, in stage c) and/or d).

12. The method as claimed in claim 11, which said lubricating agent is selected from polymer production auxiliary agents selected from: polyvinylidene fluoride, polytetrafluoroethylene, plasticizers, mineral fillers, and mixtures thereof.

13. The method as claimed in claim 1, in which the profile obtained on emergence from the shaping stage d) has, throughout its thickness, a temperature less than the crystallization temperature of the thermoplastic polymeric composition if semi-crystalline, and less than 60° C. beyond the glass transition temperature of the thermoplastic polymeric composition if amorphous.

14. The method as claimed in claim 1, in which said shaped profile has a volume of reinforcing fabric ranging from 35 to 75% relative to the total volume of the profile.

15. (canceled)

16. A composite article comprising at least one profile obtained by the method as claimed in claim 1.
